(19) United States
(12) Patent Application Publication
(10) Pub. No.: US 2013/0192365 A1
(43) Pub. Date: Aug. 1, 2013

(54) MONOLITHIC TRIAXIAL GYRO WITH IMPROVED MAIN MASSES AND COUPLING MASS COUPLED WITH THE EACH OTHER

(71) Applicants: Rui-Fen Zhuang, Suzhou City (CN); Gang Li, Suzhou City (CN)

(72) Inventors: Rui-Fen Zhuang, Suzhou City (CN); Gang Li, Suzhou City (CN)

(73) Assignee: MEMSensing Microsystems Technology Co., Ltd, Suzhou City (CN)

(21) Appl. No.: 13/561,278

(22) Filed: Jul. 30, 2012

(30) Foreign Application Priority Data
Feb. 1, 2012 (CN) 201210022206.5

(51) Int. Cl. G01C 19/56

(52) U.S. Cl. 73/504.12

(57) ABSTRACT

A monolithic triaxial gyro includes a mass block, a number of electrode groups and a drive comb group. The mass block includes main masses and a coupling mass coupled with the main masses. The main masses are positioned on opposite sides of the coupling mass and are symmetrical with each other along a Y-axis. The electrode groups include a first electrode group within an orthographic projection of the mass block, a second electrode group within an orthographic projection of the coupling mass and a third electrode group including a group of immovable slender flat plates and a group of movable slender flat plates. The drive comb group is connected to the main masses for driving movement of the main masses when signals are inputted into the drive comb group.

### BACKGROUND OF THE INVENTION

1. Field of the Invention

The present invention relates to a kind of monolithic triaxial gyro, and more particularly to a kind of MEMS monolithic triaxial gyro applied in smart phones, tablet PCs, game consoles, blind guiding of GPS, and cars etc. The present invention belongs to MEMS (Micro Electro Mechanical Systems) filed.

2. Description of Related Art

Comparing with conventional gyros, the MEMS gyros have advantages of lower profile, better integration capability, lower cost and lower energy consumption etc. The MEMS gyros mainly utilize Coriolis force effect to detect angular velocities. When a mass block is vibrating in a simple harmonic vibration manner along an invariant first direction, if there are corresponding angular velocity signals inputted along a second direction perpendicular to the first direction, Coriolis force may generate along a third direction perpendicular to both the first direction and the second direction. When the Coriolis force is applied to the mass block, the mass block will be driven to generate a replacement. The Coriolis force can be detected and measured through detecting the foregoing replacement variation and ultimately the angular velocity can be obtained. In current products, the angular velocity is obtained via a simple harmonic vibration which is driven by a force through electrostatic comb drive, and via capacitance variation for representing the replacement variation.

With development of the MEMS gyros, integration of triaxial gyros is a primary trend of consumer species and industry species. Current triaxial gyros are realized through package combination. That is, three independent single-axis gyro chips are packaged to an integration, or a single-axis gyro chip and a dual-axis gyro chip are packaged to an integration. However, such packages may render large profile and high package cost.

In recent years, a number of research institutions have tried to seek new technologies for gyro integration, and some foreign MEMS companies have developed monolithic triaxial MEMS gyros applied in the consumer species. Because the monolithic triaxial MEMS gyros have advantages of lower profile, lower cost and lower energy consumption, the monolithic triaxial MEMS gyros are the primary development trends of the triaxial gyros.

### BRIEF SUMMARY OF THE INVENTION

The present invention provides a monolithic triaxial gyro including a mass block, a plurality of electrode groups and a drive comb group. The mass block includes an even number of main masses and a coupling mass coupled with the main masses. The main masses are positioned on opposite sides of the coupling mass and are symmetrical with each other along a Y-axis. The electrode groups include a first electrode group, a second electrode group and a third electrode group. Gaps are formed between the first electrode group and the mass block and the second electrode group and the mass block, respectively. The first electrode group is positioned on opposite sides of the second electrode group and is arranged symmetrically with each other along the Y-axis. The first electrode group is within an orthographic projection of the mass block and the second electrode group is within an orthographic projection of the coupling mass. The third electrode group includes a group of immovable slender flat plates and a group of movable slender flat plates. The third electrode group is connected to the main masses through a resilient component. The drive comb group is connected to the main masses for driving movement of the main masses when signals are inputted into the drive comb group.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic perspective view of a monolithic triaxial gyro in accordance with an illustrated embodiment of the present invention;

FIG. 2 is a schematic perspective view of the monolithic triaxial gyro with a corner of which being cut out;

FIG. 3 is a schematic view of the monolithic triaxial gyro as shown in FIG. 1 and illustrates an integral frame thereof in accordance with a first embodiment of the present invention;

FIG. 4 is another schematic view of the monolithic triaxial gyro showing elaboration of FIG. 3;

FIG. 5 is a schematic view of another monolithic triaxial and illustrates an integral frame thereof in accordance with a second embodiment of the present invention;

FIG. 6 is another schematic view of the monolithic triaxial gyro showing elaboration of FIG. 5;

FIG. 7 is another schematic view of the monolithic triaxial gyro showing elaboration of FIG. 6; and

FIG. 8 is a schematic view of another monolithic triaxial and illustrates an integral frame thereof in accordance with a third embodiment of the present invention.

### DETAILED DESCRIPTION OF THE PREFERRED EMBODIMENTS

Reference will now be made to the drawing figures to describe the preferred embodiment of the present invention in detail. The working theory of the monolithic triaxial gyro according to the present invention is as follows: when a drive mass is driven to vibrate in a simple harmonic vibration manner along a first axis, and simultaneously, if there are angular velocity signals inputted along a second axis perpendicular to the foregoing vibration direction, force signals called Coriolis force may generate along a third axis perpendicular to the first axis and the second axis. The Coriolis force is in proportion to the drive mass, the vibration velocity and the inputted angular velocity signals. When the drive mass and the vibration velocity are invariant, the inputted angular velocity signals can be reflected and concluded by detecting the Coriolis force. The Coriolis force is obtained by detecting the capacitance variance resulted from corresponding displacement variance of the drive mass. Corresponding formula is F=m*a=k*x, wherein “F” represents force, “m” represents the drive mass, “a” represents the angular velocity, and “x” represents the displacement of the drive mass.

The drive detection mode includes static comb driving (drive comb group) and flat capacitance detecting (electrode groups). In the illustrated embodiment of the present invention, total two kinds of masses, including a kind of main mass and a kind of coupling mass, are specified. The main mass is loaded by voltage and is driven to realize simple harmonic vibration by the static electricity, while the coupling mass is guided to realize simple harmonic vibration by the main mass. Therefore, according to the monolithic triaxial gyro of the present invention, the angular velocities of two axes are detected/measured from the single main mass and the angular velocity of the remaining third axis is detected/measured from the coupling mass.

In order to better understand the present invention, illustrated embodiments will be described in detail.

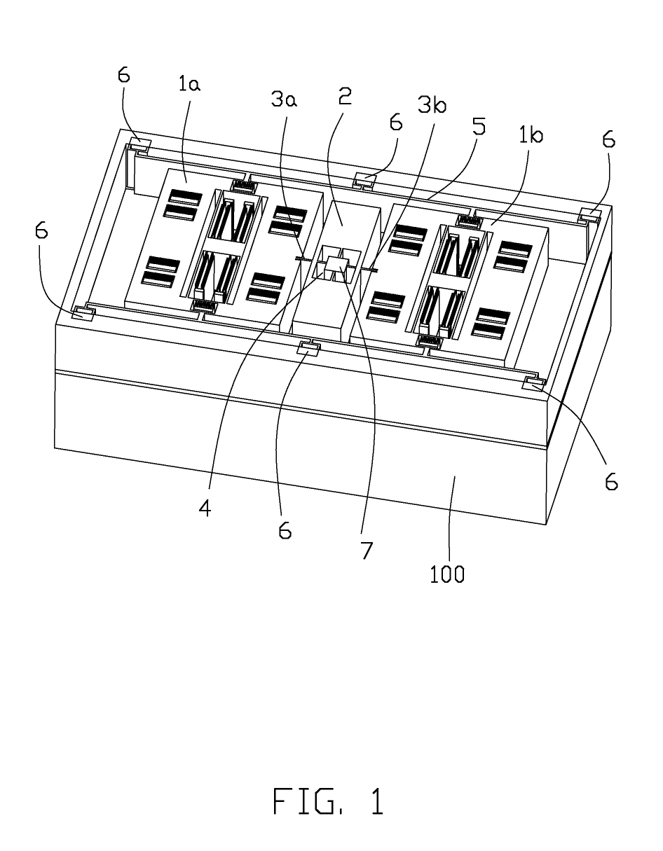

Referring to FIGS. 1 to 3, according to a first embodiment of the present invention, the monolithic triaxial gyro includes a mass block, first and second anchors 6, 7 connected to a base 100, and first and second resilient components 5, 4. The mass block includes an even number of main masses further including a first mass 1a and a second mass 1b, and a coupling mass 2 coupled with the first mass 1a and the second mass 1b. The first and the second anchors 6, 7 can be regarded as immovable parts. The first resilient component 5 is provided with high elasticity along the Y-axis and high rigidity along the X-axis.

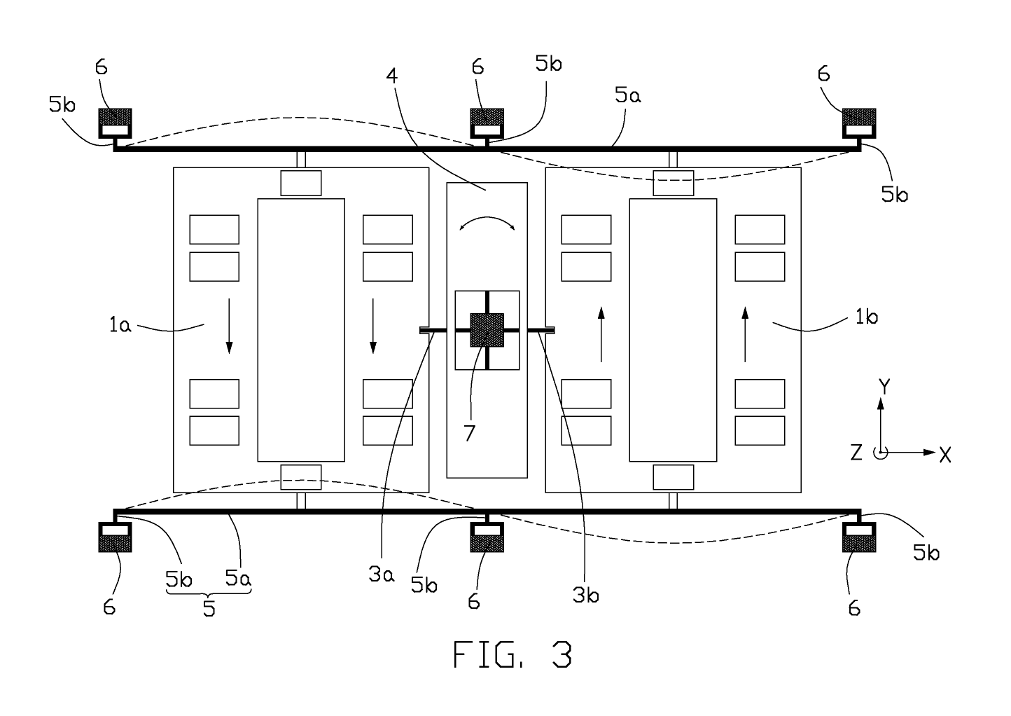

The first mass 1a and the second mass 1b are positioned on opposite sides of the coupling mass 2 and are arranged symmetrically with each other along the Y-axis. The first mass 1a and the second mass 1b are vibrational along opposite directions along the Y-axis as shown by broken lines of FIG. 3. In the illustrated embodiment, the first anchors 6 are multiple and the first anchors 6 function as movement anchors for supporting the first mass 1a and the second mass 1b. One side of the first resilient component 5 is connected to the first anchors 6 and the other side is connected to the first mass 1a and the second mass 1b for supporting reciprocating vibration of the first mass 1a and the second mass 1b. The first resilient component 5 is also symmetrical along the Y-axis. Because the first and the second masses 1a, 1b and the first resilient component 5 are arranged symmetrically along the Y-axis, the first resilient component 5 has high elasticity along the Y-axis and high rigidity along the X-axis, as a result that displacements of the first and the second masses 1a, 1b only generate along the Y-axis. Therefore, the Y-axis is a first drive axis of the monolithic triaxial gyro, and the first and the second masses 1a, 1b are relevant drive masses.

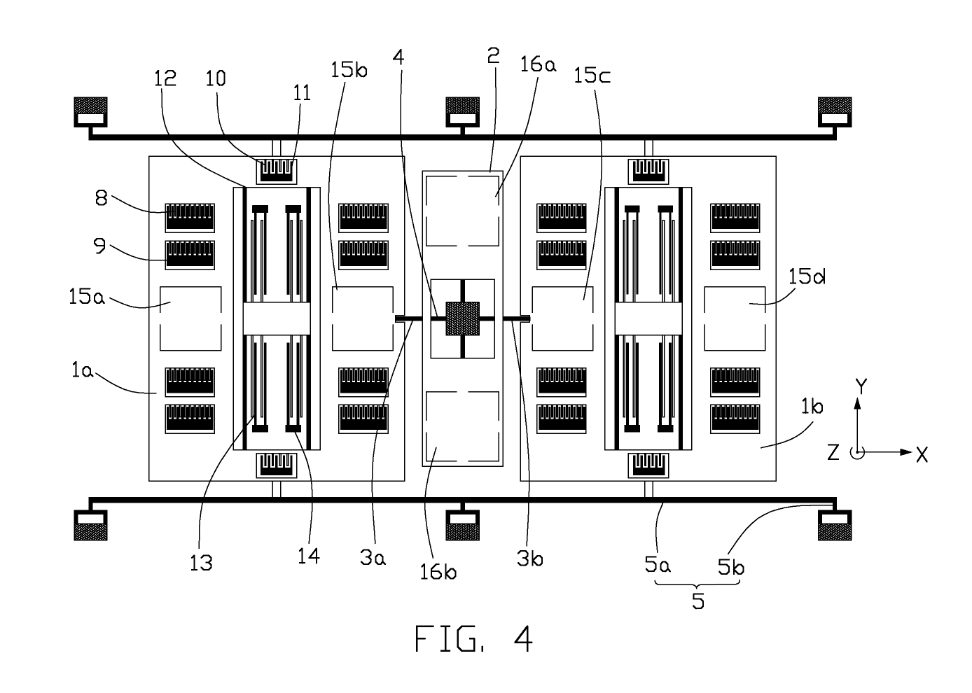

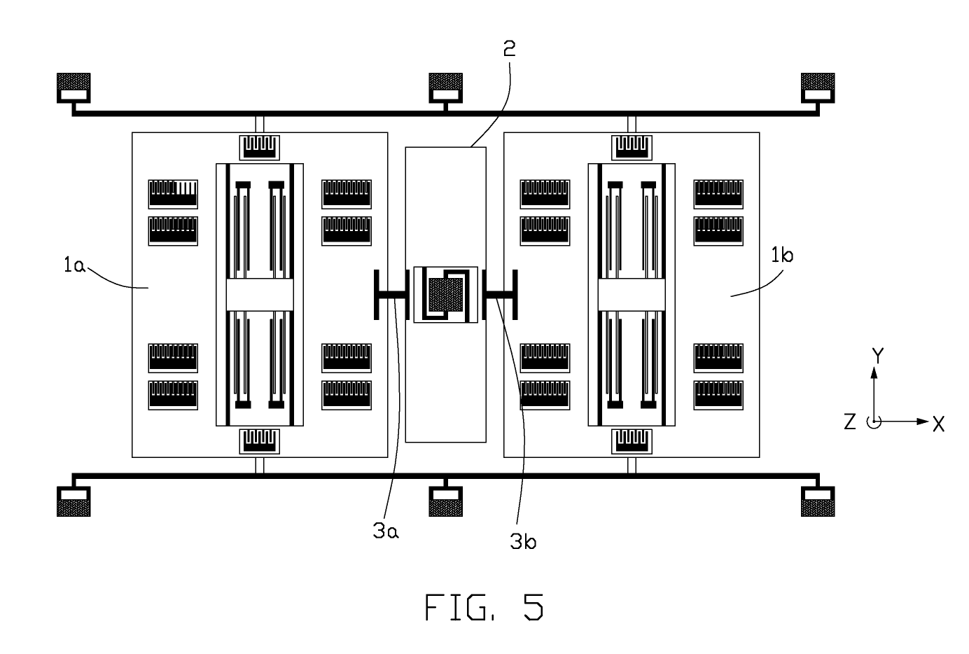

Referring to FIGS. 3 and 4, under the vibration of the first and the second masses 1a, 1b, the coupling mass 2 appears reciprocating torsional vibration as shown by the arrows in the coupling mass 2. In other words, the coupling mass 2 is torsional along the Z-axis. Therefore, the Z-axis is a second drive axis of the monolithic triaxial gyro, and the coupling mass 2 is the relevant drive mass. The first mass 1a and the second mass 1b are coupled to the coupling mass 2 so as to realize coupling through coupling beams 3a, 3b. Since the first and the second masses 1a, 1b need to guide the torsion of the coupling mass 2, the coupling beams 3a, 3b should have reasonable rigidity along the Y-axis for transmitting displacement load resulted from the static electricity force. However, the rigidity should not be too robust to restrain the simple harmonic vibration of the coupling mass 2. Since the deformation of the coupling beams 3a, 3b may reflect the stress of the first and the second masses 1a, 1b and the coupling mass 2, the stress can be decreased through optimizing the configuration of the coupling beams 3a, 3b. For example, the coupling beams 3a, 3b can be I-shaped beams as shown in FIG. 5. Understandably, the coupling beams 3a, 3b can also be set in other configurations. The second anchor 7 functions as a movement anchor for supporting the coupling mass 2. One end of the second resilient component 4 is connected to the second anchor 7, and the other end of the second resilient component 4 is connected to the coupling mass 2 for supporting torsion of the coupling mass 2.

The first resilient component 5 is connected to the first anchors 6 and the first and the second masses 1a, 1b. The first resilient component 5 is direct to the resonance rigidity and the resonance frequency can be adjusted by the configuration and the dimension of the first resilient component 5. In order to decrease stress influence and anchor damage, according to the illustrated embodiment of the present invention, the first resilient component 5 includes a long beam 5a connected to the first and the second masses 1a, 1b, and a short beam 5b connected to the first anchors 6. The second resilient component 4 is connected to second anchor 7 and the coupling mass 2 for supporting torsion of the coupling mass 2 along the X-axis direction and the Y-axis direction. According to the illustrated embodiment, the second resilient component 4 includes four intercrossed beams symmetrical to both the X-axis and the Y-axis. Besides, the second resilient component 4 can also be set as or similar I-shape beams as shown in FIG. 5. The resonance frequency of the coupling mass 2 can be adjusted by controlling the torsion rigidity. That is to say, the resonance frequency of the coupling mass 2 can be adjusted by adjusting the dimension of the second resilient component 4 or by adjusting the size and the dimension of the coupling mass 2.

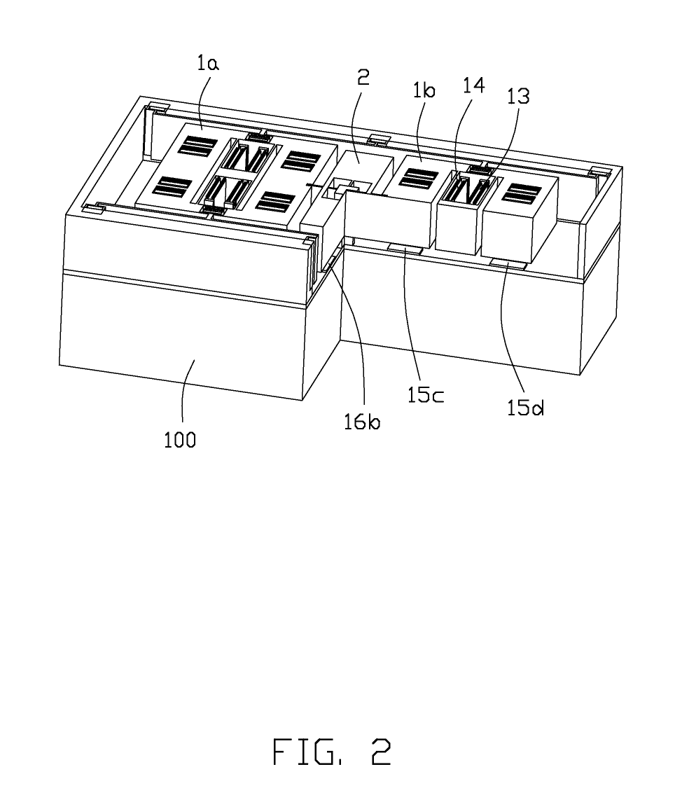

Referring to FIGS. 2 and 4, the monolithic triaxial gyro further includes a drive comb group and a plurality of electrode groups. The drive comb group includes a plurality of drive combs each of which includes a movable drive comb 8 and an immovable drive comb 9. The immovable drive comb 9 is adapted for inputting signals and for driving movement of the main masses. According to this embodiment, the inputting signals include DC (Direct Current) and AC (Alternating Current) voltage signals. The electrode groups include a first electrode group 15a˜15d, a second electrode group 16a, 16b and a third electrode group. Gaps are formed between the first electrode group 15a˜15d and the mass block and the second electrode group 16a, 16b and the mass block, respectively. The first electrode group 15a˜15d is positioned on opposite sides of the second electrode group 16a, 16b and is arranged symmetrically with each other along the Y-axis. Besides, the first electrode group 15a˜15d is within an orthographic projection of the mass block. The second electrode group 16a, 16b is within an orthographic projection of the coupling mass 2. The third electrode group includes a group of immovable slender flat plates 14 and a group of movable slender flat plates 13. The third electrode group is symmetrically set in the first mass 1a and the second mass 1b, and the third electrode group is connected to the first and the second masses 1a, 1b through a resilient component, such as a support beam 12. The support beam 12 is adapted for supporting and controlling the displacement of the movable slender flat plates 13 along the X-axis.

Since the Coriolis force is in proportion to the vibration amplitude of the drive axis, the variety of the vibration amplitude of the drive axis will directly influence output angular velocity of MEMS gyro, as a result that it is important to keep the vibration amplitude invariable regarding the performance of the MEMS gyro. According to the illustrated embodiment of the present invention, a closed-loop negative feedback system is adopted for realizing invariable vibration amplitude which will describe in detail hereinafter. Referring to FIG. 4, the monolithic triaxial gyro further includes a detect comb group which cooperates with the drive comb group to form the closed-loop negative feedback system. The detect comb group includes a driving detect comb 10 and an immovable comb 11. When DC and AC voltage signals are applied to the immovable drive comb 9, a drive static electricity force generates along the Y-axis direction. The first and the second masses 1a, 1b are driven by the drive static electricity force to generate a displacement signal. The immovable comb 11 is corresponding to detection side. The immovable comb 11 is adapted for real-time detection of inputting signals inputted into the immovable drive comb 9 to keep the invariable vibration amplitude of the movable drive comb via the feedback format.

Referring to FIG. 4, the detect mode of the monolithic triaxial gyro will be described in detail.

When there is some angular velocity signals inputted from the X-axis direction, the first and the second masses 1a, 1b function as a drive mass and vibrate reciprocatively along opposite directions of the Y-axis. Under this condition, Coriolis force generates in opposite directions along the Z-axis. Under the function of the first resilient component 5, the first mass 1a generates a replacement far from the base 100 along the positive Y-axis direction, and the second mass 1b generates a replacement near to the base 100 along the negative Y-axis direction. The above replacements make the capacitance of the first electrode group 15a˜15d (e.g. the broken parts of the first and the second masses 1a, 1b as shown in FIG. 4) under the first mass 1a and the second mass 1b variable. In detail, since electrode layers 15a, 15b of the first electrode group 15a˜15d have a replacement far from the base 100 along the positive Y-axis direction, the capacitance of the electrode layers 15a, 15b becomes higher. Simultaneously, since electrode layers 15c, 15d of the first electrode group 15a˜15d have a replacement near to the base 100 along the negative Y-axis direction, the capacitance of the electrode layers 15c, 15d becomes lower. The Coriolis force can be detected and measured through detecting the foregoing capacitance variation. The Coriolis force reflects the angular velocity signals inputted from the X-axis direction. The above detection can be realized by detecting differential capacitance.

When there is some angular velocity signals inputted from the Y-axis direction, the coupling mass 2, which is torsional all along the Z-axis, functions as a drive mass and Coriolis force generates along a rotation direction of the X-axis. Under the function of the second resilient component 4, the coupling mass 2 generates a replacement far from the base 100 along the positive Z-axis direction, and simultaneously generates a replacement near to the base 100 along the negative Z-axis direction. The above replacements make the capacitance between the coupling mass 2 and the electrode layers 16a, 16b below the coupling mass 2 (e.g. the broken parts of the coupling mass 2 as shown in FIG. 4) variable. In detail, since the electrode layer 16a has a replacement far from the base 100 along the positive Z-axis direction, the capacitance thereof becomes lower. Simultaneously, since the electrode layer 16b has a replacement near to the base 100 along the negative Z-axis direction, the capacitance thereof becomes higher. The Coriolis force can be detected and measured through detecting the foregoing capacitance variation. The Coriolis force reflects the angular velocity signals inputted from the Y-axis direction. The above detection can be realized by detecting differential capacitance.

When there is some angular velocity signals inputted from the Z-axis direction, the first and the second masses 1a, 1b function as a drive mass along the Y-axis. Under this condition, Coriolis force generates in opposite directions along the X-axis. Under the function of the support beam 12, the movable slender flat plates 13 generate a replacement along the X-axis direction, and the immovable slender flat plates 14 are immovable. As a result, the Coriolis force can be detected and measured through detecting capacitance variation between the movable slender flat plates 13 and the immovable slender flat plates 14 and resulting from the foregoing replacement. The Coriolis force reflects the angular velocity signals inputted from the Z-axis direction. The above detection can be realized via differential detection through reasonable design (e.g. dimension and loading location) of the movable slender flat plates 13 and the immovable slender flat plates 14.

Characteristics, such as the detection sensitivity and the band width, of the gyro are relative to the frequency differentiation of the drive axis and the detect axis. In detail, the smaller the frequency differentiation, the higher the sensitivity and the narrower the band width appear. The sensitivity and the band width are two mutual inhibition parameters and they can be adjusted according to different applications of the gyro. Besides, the resonance frequency is relative to the rigidity and the mass of corresponding mass block, among which the rigidity is determined by relative resilient components of the gyro. Therefore, the performance of the gyro can be adjusted by reasonable designing the size and the dimension of the first resilient component 5, the second resilient component 4 and the support beam 12.

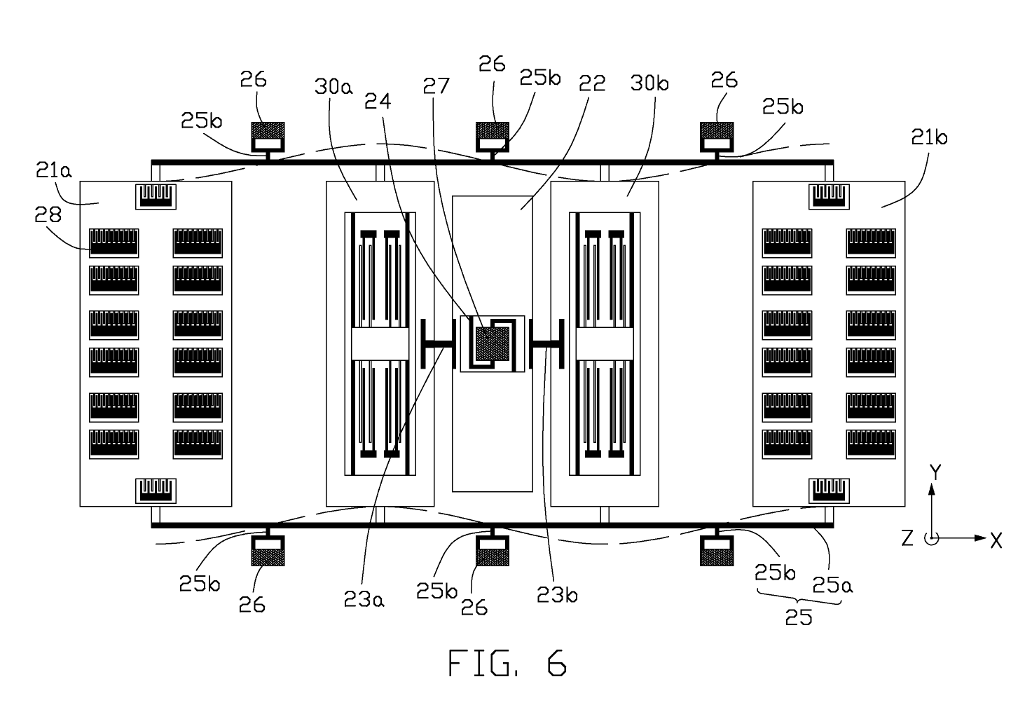

Referring to FIG. 6, a second embodiment of the present invention similar to the first embodiment is disclosed. For the following brief description, corresponding components of the first and the second embodiments are designated with the same denotation. The main masses include a first mass 21a, a second mass 21b, a third mass 30a and a fourth mass 30b. The main masses are positioned on opposite sides of a coupling mass 22 and are arranged symmetrically with each other along the Y-axis. Similar to the first embodiment, under the drive of movable drive combs 28, the first and the second masses 21a, 21b reciprocatively vibrate along opposite directions along the Y-axis as shown in broken lines of FIG. 6. The first anchors 26 are directly connected to the base (not shown) and the first anchors 26 can be regarded as immovable parts. One end of the first resilient component 25 is connected to the first anchors 26 and the other end is connected to the first and the second masses 21a, 21b for supporting reciprocating vibration of the first and the second masses 21a, 21b. The first resilient component 25 includes a long beam 25a connected to the main masses and a short beam 25b connected to the first anchors 26. Because the first and the second masses 21a, 21b and the first resilient component 25 are arranged symmetrically along the Y-axis, the first resilient component 25 has high elasticity along the Y-axis and high rigidity along the X-axis, as a result that displacement of the first and the second masses 21a, 21b only generates along the Y-axis. Therefore, the Y-axis is a first drive axis of the monolithic triaxial gyro, and the first and the second masses 21a, 21b are relevant drive masses.

Under the vibration guidance of the first and the second masses 21a, 21b, the third and the fourth masses 30a, 30b appear similar reciprocative vibration along opposite directions along the Y-axis as shown by broken lines of FIG. 6. Under the vibration of the third and the fourth masses 30a, 30b, the coupling mass 22 appears of reciprocating torsional vibration. In other words, the coupling mass 22 is torsional along the Z-axis. Similar to the first embodiment, the Z-axis is a second drive axis of the monolithic triaxial gyro, and the coupling mass 22 is the relevant drive mass. The third mass 30a and the fourth mass 30b are coupled to the coupling mass 22 so as to realize coupling through coupling beams 23a, 23b. The second anchor 27 functions as a movement anchor for supporting the coupling mass 22. One end of the second resilient component 24 is connected to the second anchor 7, and the other end of the second resilient component 24 is connected to the coupling mass 22 for supporting torsion of the coupling mass 22.

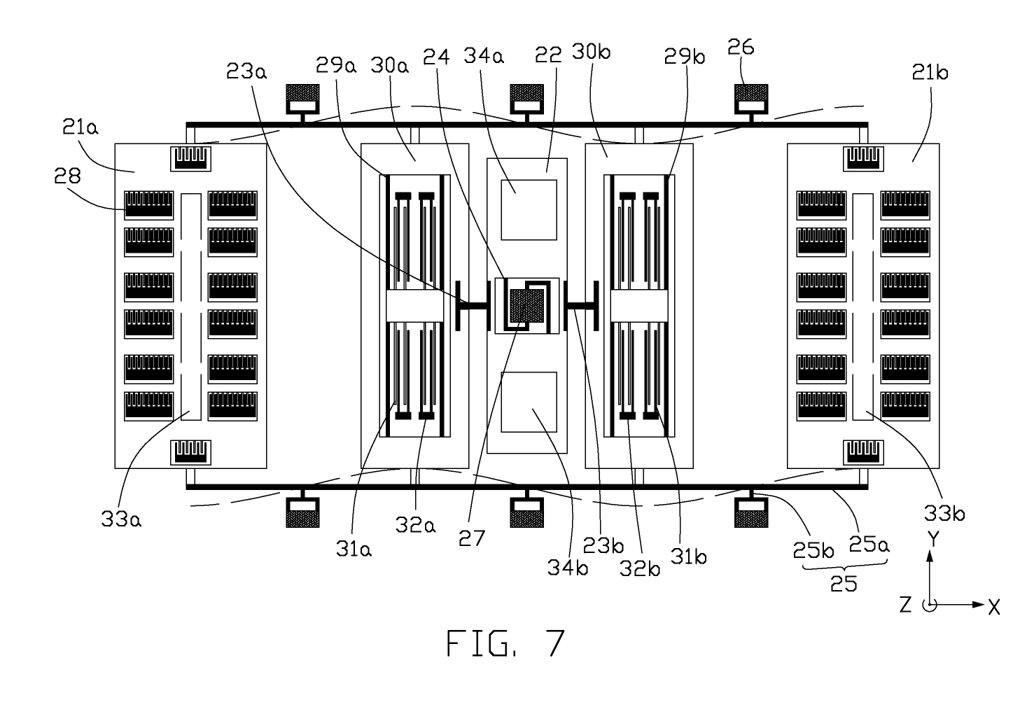

Referring to FIG. 7, an integral frame, including a driving part and a detecting part, of the monolithic triaxial gyro is disclosed. The detect mode of the monolithic triaxial gyro which is similar to the first embodiment will be described in detail.

When there is some angular velocity signals inputted from the X-axis direction, the first and the second masses 21a, 21b function as a drive mass and vibrate reciprocatively along opposite directions of the Y-axis. Under this condition, Coriolis force generates in opposite directions along the Z-axis. Under the function of the first resilient component 25, the first mass 21a generates a replacement far from the base along the positive Y-axis direction, and the second mass 21b generates a replacement near to the base along the negative Y-axis direction. The above replacements make the capacitance of the electrode layers 33a, 33b of the first electrode group (e.g. the broken parts of the first and the second masses 21a, 21b as shown in FIG. 7) under the first mass 21a and the second mass 21b variable. In detail, since the electrode layer 33a has a replacement far from the base along the positive Y-axis direction, the capacitance thereof becomes lower. Simultaneously, since the electrode layer 33b has a replacement near to the base along the negative Y-axis direction, the capacitance thereof becomes higher. The Coriolis force can be detected and measured through detecting the foregoing capacitance variation. The Coriolis force reflects the angular velocity signals inputted from the X-axis direction. The above detection can be realized by detecting differential capacitance.

When there is some angular velocity signals inputted from the Y-axis direction, the coupling mass 21, which is torsional all along the Z-axis, functions as a drive mass and Coriolis force generates along a rotation direction of the X-axis. Under the function of the second resilient component 24, the coupling mass 22 generates a replacement far from the base along the positive Z-axis direction, and simultaneously generates a replacement near to the base along the negative Z-axis direction. The above replacements make the capacitance between the coupling mass 22 and the electrode layers 34a, 34b below the coupling mass 22 (e.g. the broken parts of the coupling mass 22 as shown in FIG. 7) variable. In detail, since the electrode layer 34a has a replacement far from the base along the positive Z-axis direction, the capacitance thereof becomes lower. Simultaneously, since the electrode layer 34b has a replacement near to the base along the negative Z-axis direction, the capacitance thereof becomes higher. The Coriolis force can be detected and measured through detecting the foregoing capacitance variation. The Coriolis force reflects the angular velocity signals inputted from the Y-axis direction. The above detection can be realized by detecting differential capacitance.

When there is some angular velocity signals inputted from the Z-axis direction, the first and the second masses 21a, 21b function as a drive mass along the Y-axis. Under this condition, Coriolis force generates in opposite directions along the X-axis. Under the function of the support beams 29a, 29b, the movable slender flat plates 31a, 31b generate a replacement along the X-axis direction, and the immovable slender flat plates 32a, 32b are immovable. As a result, the Coriolis force can be detected and measured through detecting capacitance variation between the movable slender flat plates 31a, 31b and the immovable slender flat plates 32a, 32b and resulting from the foregoing replacement. The Coriolis force reflects the angular velocity signals inputted from the Z-axis direction. The above detection can be realized via differential detection through reasonable design (e.g. dimension and loading location) of the movable slender flat plates 31a, 31b and the immovable slender flat plates 32a, 32b.

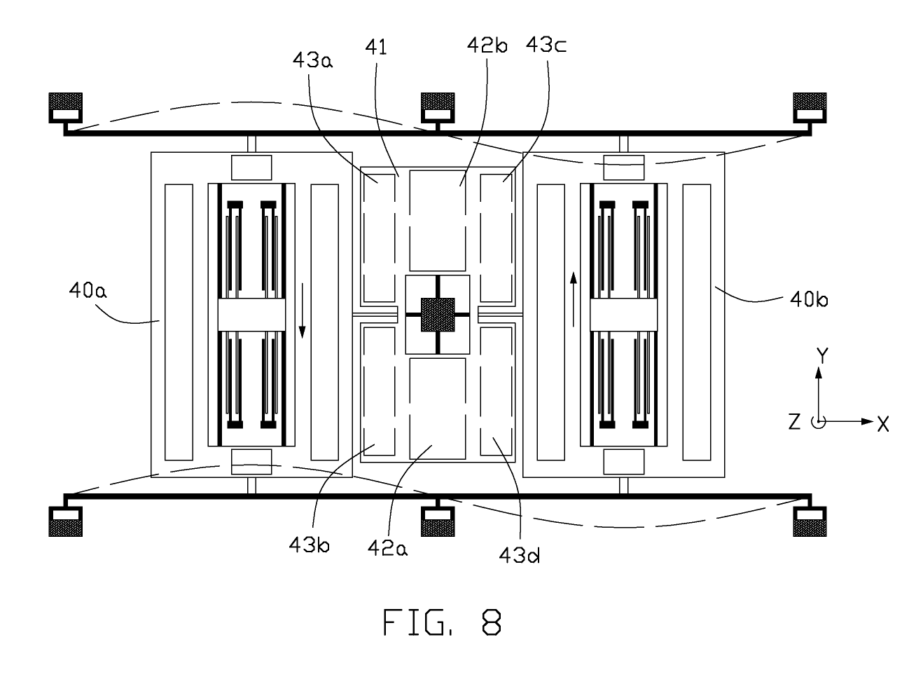

Referring to FIG. 8, a third embodiment of the present invention similar to the first embodiment is disclosed. For the following brief description, corresponding components of the first and the third embodiments are designated with the same denotation. The main masses include a first mass 40a and a second mass 40b. The first and the second masses 40a, 40b are positioned on opposite sides of the coupling mass 41 and are arranged symmetrically with each other along the Y-axis. The first and the second masses 40a, 40b are coupled to the coupling mass 41 through coupling beams (not shown) the same as the first embodiment. The first electrode group 43a-43d and the second electrode group 42a, 42b are within the orthographic projection of the coupling mass 41. The first electrode group 43a-43d is positioned on opposite sides of the second electrode group 42a, 42b and are arranged symmetrically with each other along the Y-axis. The drive detection along the Y-axis and the Z-axis of the third embodiment is the same as the first embodiment so that repeated description thereof is omitted herein.

Referring to FIG. 8, the difference between the first embodiment and the third embodiment is that drive and detection of the angular-velocity along the X-axis direction is shifted from commonly combined with the drive axis of the angular-velocity along the Z-axis to commonly combined with the drive axis of the angular-velocity along the Y-axis. In detail, when there is some angular velocity signals inputted from the X-axis direction, the coupling mass 41 functions as a drive mass and vibrates reciprocatively so as to drive the coupling mass 41 rotatable along the Y-axis. Under this condition, the coupling mass 41 generates a replacement far from the base along the positive Z-axis direction, and simultaneously generates a replacement near to the base along the negative Z-axis direction. That is to say, the electrode layers 43a, 43b generate a replacement far from the base along the positive Z-axis direction, and the electrode layers 43c, 43d generate a replacement near to the base along the negative Z-axis direction. The above replacements make the capacitance between the coupling mass 41 and the electrode layers 43a-43d of the first electrode group (e.g. the broken parts of the coupling mass 41 as shown in FIG. 8) under the coupling mass 41 variable. The capacitance of the electrode layers 43a, 43b becomes lower while the capacitance of the electrode layers 43c, 43d becomes higher simultaneously. The Coriolis force can be detected and measured through detecting the foregoing capacitance variation. The Coriolis force reflects the angular velocity signals inputted from the X-axis direction. As shown in FIG. 8, the electrode layers 42a, 42b of the second electrode group function as detect electrode layers of the angular-velocity along the Y-axis direction.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A monolithic triaxial gyro comprising:
a mass block comprising an even number of main masses and a coupling mass coupled with the main masses, the main masses being positioned on opposite sides of the coupling mass and being symmetrical with each other along a Y-axis;
a plurality of electrode groups comprising a first electrode group, a second electrode group and a third electrode group, gaps being formed between the first electrode group and the mass block and the second electrode group and the mass block, respectively, the first electrode group being positioned on opposite sides of the second electrode group and being arranged symmetrically with each other along the Y-axis, the first electrode group being within an orthographic projection of the mass block and the second electrode group being within an orthographic projection of the coupling mass, the third electrode group comprising a group of immovable slender flat plates and a group of movable slender flat plates, the third electrode group being connected to the main masses through a resilient component; and
a drive comb group connected to the main masses for driving movement of the main masses when signals are inputted into the drive comb group.

2. The monolithic triaxial gyro as claimed in claim 1, further comprising a first anchor connected to the main masses and a second anchor connected to the coupling mass.

3. The monolithic triaxial gyro as claimed in claim 2, wherein the first anchor is connected to the main masses through a first resilient component and the second anchor is connected to the coupling mass through a second resilient component.

4. The monolithic triaxial gyro as claimed in claim 3, wherein the first resilient component comprises a long beam connected to the main masses and a short beam connected to the first anchor.

5. The monolithic triaxial gyro as claimed in claim 1, further comprising a detect comb group which cooperates with the drive comb group to form a closed-loop negative feedback system.

6. The monolithic triaxial gyro as claimed in claim 1, wherein the first electrode group is within an orthographic projection of the main masses.

7. The monolithic triaxial gyro as claimed in claim 1, wherein the first electrode group is within the orthographic projection of the coupling mass.

8. The monolithic triaxial gyro as claimed in claim 1, wherein the third electrode group is arranged symmetrically with each other in the main masses along the Y-axis.

9. The monolithic triaxial gyro as claimed in claim 1, wherein the resilient component comprises a support beam.

10. The monolithic triaxial gyro as claimed in claim 1, wherein the drive comb group comprises a plurality of drive combs each of which comprises a movable drive comb and an immovable drive comb.

11. The monolithic triaxial gyro as claimed in claim 1, wherein the main masses and the coupling mass are coupled with each other through a coupling beam.

12. The monolithic triaxial gyro as claimed in claim 11, wherein the coupling beam is I-shaped.

13. The monolithic triaxial gyro as claimed in claim 3, wherein the main masses comprise a first mass and a second mass, and the first resilient component is provided with high elasticity along the Y-axis and high rigidity along an X-axis perpendicular to the Y-axis so that displacements of the first mass and the second mass only generate along the Y-axis.

14. The monolithic triaxial gyro as claimed in claim 13, wherein the coupling mass is torsional along a Z-axis perpendicular to both the X-axis and the Y-axis under the vibration of the first mass and the second mass.

15. The monolithic triaxial gyro as claimed in claim 13, further comprising a second resilient component connected to the second anchor and the coupling mass.

16. The monolithic triaxial gyro as claimed in claim 15, wherein the second resilient component comprises four intercrossed beams symmetrical to both the X-axis and the Y-axis.

17. The monolithic triaxial gyro as claimed in claim 1, wherein the main masses comprise a first mass, a second mass, a third mass and a fourth mass, the first mass and the second mass being symmetrical to the third mass and the fourth mass along the Y-axis.

18. The monolithic triaxial gyro as claimed in claim 13, further comprising a base for supporting the mass block, the first anchor and the second anchor being connected to the base.

19. The monolithic triaxial gyro as claimed in claim 18, wherein when angular velocity signals are inputted from an X-axis direction, the first mass and the second mass function as a drive mass and vibrate reciprocatively along opposite directions of the Y-axis, the first mass generates a replacement far from the base along a positive Y-axis direction, and the second mass generates another replacement near to the base along a negative Y-axis direction.

20. The monolithic triaxial gyro as claimed in claim 18, wherein when angular velocity signals are inputted from a Y-axis direction, the coupling mass functions as a drive mass, the coupling mass generates a replacement far from the base along a positive Z-axis direction and simultaneously generates another replacement near to the base along a negative Z-axis direction.
